(19) United States
(12) Patent Application Publication
(10) Pub. No.: US 2004/0057693 A1
(43) Pub. Date: Mar. 25, 2004

(54) Polycarbonate optical fibre

(76) Inventors: Wolfgang Ebert, Krefeld (DE); Hans-Josef Behrens, Dormagen (DE); Heniz-Dieter Brandt, Willich (DE); Martina Brandt, Willich (DE); Franziska Hanne Brandt, Willich (DE); Inken Margarethe Brandt, Willich (DE); Thomas Follinger, Dormagen (DE); Wilfried Haese, Odenthal (DE)

Correspondence Address: BAYER POLYMERS LLC, 100 BAYER ROAD, PITTSBURGH, PA, 15205, US

(21) Appl. No.: 10/381,613

(22) PCT Filed: Sep. 19, 2001
(86) PCT No.: PCT/EP01/10797

(30) Foreign Application Priority Data
Oct. 2, 2000 (DE) 100 48 796.3

(51) Int. Cl. G02B 6/00; G02B 6/16

(52) U.S. Cl. 385/143

(57) ABSTRACT

Optical fibers suitable for transmission of optical signals and comprising a core that contains polycarbonate are disclosed. The polycarbonate is characterized in its low content of insoluble particles.

The present invention provides polycarbonate with a low particle content, the use of this polycarbonate to produce light guides, light guides including a core containing said polycarbonate, a process for producing said light guides, the use of said light guides to transfer optical signals in means of transport and means of transport containing said light guides.

Light guides are used to transfer optical signals. Light guides contain a core made of optically transparent material. The core may consist, for example, of glass or a plastics material. The core is also called a fibre. The core or the fibre may have any cross-section and diameter at all. In practice, the cross-section and diameter are chosen in accordance with the current technical requirements.

The core of the light guides is usually coated. The coating may consist, for example, of a plastics material or a lacquer. The coating offers a certain degree of protection against mechanical effects on the core. Furthermore, the coating improves the efficiency of transfer of optical signals by the light guide. Thus, the mechanical and optical properties of the coating in particular are important.

This system of core and coating may be surrounded by a sleeve or a casing. This is used, for example, to protect against damage and effects of the environment.

Transfer of the optical signal, preferably by visible light, takes place in light guides primarily in the core. Thus the optical properties of the core in particular are important. It is especially desirable that the damping coefficient of the core is small, so that signal transfer can take place over large distances without too large a loss in signal intensity occurring.

Light guides including a polycarbonate fibre as core are known. A disadvantage is the high damping coefficient of known grades of polycarbonate.

Light guides based on plastics coated polycarbonate fibres are known from:

(a) EP-A 0 203 327;

(b) JP-A 84/216 104;

(c) JP-A 84/216 105;

(d) JP-A 84/218 404;

(e) JP-A 86/231 510;

(f) JP-A 86/240 206;

(g) JP-A 86/245 110;

(h) JP-A 86/278 807.

In these publications, light guides based on polycarbonate fibres are described in which the polycarbonate cores are coated with specific fluorine-containing polymers ((a), (e), (f), (h)), with specific mixed polymers of methyl methacrylates, styrene or vinyltoluene and maleic anhydride (b), with specific mixed polymers of methyl methacrylates, α-methylstyrene and maleic anhydride (c), with specific mixed polymers of methyl methacrylate, α-methylstyrene, styrene and maleic anhydride (d) and with silicone resins, silicone/acrylate resins, urethane/acrylate resins, polyamides or poly-4-methylpentene-1 (g).

These plastics, which have hitherto been proposed for coating polycarbonate fibres, are disadvantageous because they have inadequate heat resistance (b), (c), (d), too low an elongation at break (b), (c), (d), (g) and/or inadequate adhesion to the polycarbonate (a), (e), (f), (g), (h), are too costly for application on an industrial scale and thus too expensive ((a), (e), (f), (h)), and/or lead to the formation of stress cracks in the polycarbonate core (g).

It is known that mixtures of polyfunctional and monofunctional acrylates or methacrylates which are polymerisable by UV irradiation can be used for coating glass fibres to be used as light guides (see e.g. EP-A 0 125 710, EP-A 0 145 929, EP-A 0 167 199, DE-A 3 522 980).

These mixtures, developed for coating glass fibres, are unsuitable for polycarbonate fibres because they lead to the formation of stress cracks in the polycarbonate core and in addition to too high a refractive index.

EP-A 0 327 807 discloses light guides with a core of polycarbonate and a coating of polymerised acrylates and/or methacrylates.

The object of the invention is to provide polycarbonate, the damping coefficient of which is low so that it can be used to produce high-quality light guides.

Furthermore, the object of the invention comprises providing light guides including a core containing the polycarbonate according to the invention and also providing a process for producing these light guides as well as providing means of transport containing the light guides according to the invention.

The advantageous properties of polycarbonate fibres, in particular high transparency, high refractive index, high heat resistance, good mechanical properties such as e.g. high bending strength and high breaking strength and also low capacity for the absorption of water, should not be impaired.

It has now been found that the objects according to the invention can be achieved with polycarbonate in which the concentration of particles which are insoluble in polycarbonate does not exceed a certain value.

The invention provides polycarbonate containing less than 80 000 particles per gram of polycarbonate of particles insoluble in polycarbonate with a size of 0.3 to 10 μm, preferably less than 45 000 particles/g with a size of 0.3 to 0.6 μm and less than 30 000 particles/g with a size of 0.6 to 1.0 μm and less than 3 000 particles/g with a size of 1.0 to 2.0 μm and less than 500 particles/g with a size of 2.0 to 5.0 μm and less than 200 particles/g with a size of 5.0 to 10 μm, particularly preferably less than 30 000 particles/g with a size of 0.3 to 0.6 μm and less than 20 000 particles/g with a size of 0.6 to 1.0 μm and less than 2 000 particles/g with a size of 1.0 to 2.0 μm and less than 300 particles/g with a size of 2.0 to 5.0 μm and less than 100 particles/g with a size of 5.0 to 10 μm, very particularly preferably less than 25 000 particles/g with a size of 0.3 to 0.6 μm and less than 10 000 particles/g with a size of 0.6 to 1.0 μm and less than 1 500 particles/g with a size of 1.0 to 2.0 μm and less than 50 particles/g with a size of 2.0 to 5.0 μm and less than 20 particles/g with a size of 5.0 to 10 μm.

Furthermore, the invention provides use of the polycarbonate according to the invention to produce light guides.

Furthermore, the invention provides light guides including a core containing the polycarbonate according to the invention.

Light guides in which the core is coated are preferred.

Particularly preferred are light guides in which the coating contains a polymer which contains repeating units derived from the monomers

A) one or more different compounds of the formula (I)

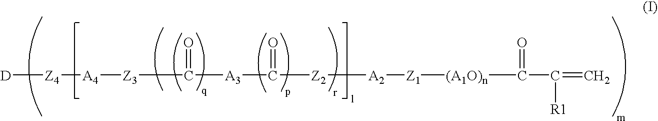

in which

m represents 2, 3 or 4,

D represents the m-valent group from an aliphatic or aromatic hydrocarbon,

R₁ is hydrogen or methyl,

Z₁, Z₂ and Z₃, independently, represent oxygen, sulfur, the —N(R) group (in which R is hydrogen or unsubstituted or substituted, preferably unsubstituted, alkyl, aralkyl or aryl) or a divalent group of the formula (II)

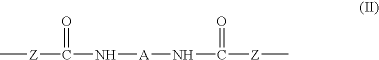

in which

Z represents oxygen, sulfur or the —N(R) group, and

A represents an unsubstituted or substituted, preferably unsubstituted, divalent group from an aliphatic, cycloaliphatic, araliphatic or aromatic hydrocarbon,

Z₄ represents oxygen, the divalent group of the formula (II) or one of the following divalent groups

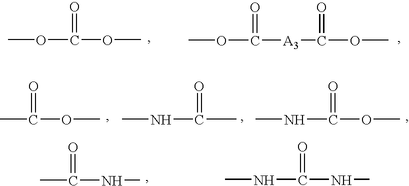

A₁, A₂, A₃ and A₄, independently, represent an unsubstituted or substituted, preferably unsubstituted, divalent group from an aliphatic, cycloaliphatic, aromatic-aliphatic or aromatic hydrocarbon,

n is zero or an integer from 1 to 20,

p, q and r, independently, may take on the value zero or 1 and

l has a numerical value such that the weight average of the molecular weight of the compound of the formula (I) is 450 to 5000, and

B) one or more different compounds of the formula (III)

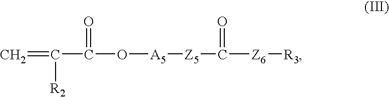

in which

R₂ is hydrogen or methyl,

A₅ represents an unsubstituted or substituted, preferably unsubstituted, divalent group from an aliphatic or cycloaliphatic hydrocarbon,

Z₅ and Z₆, independently, represent oxygen, sulfur or the —N(R′) groups, in which R′ is hydrogen or unsubstituted or substituted, preferably unsubstituted alkyl, aralkyl or aryl, and

R₃ is an optionally substituted alkyl, cycloalkyl or aralkyl group.

Very particularly preferably, the said light guides are those in which A₁, A₂, A₃, A₄ and A, independently, represent an unsubstituted or substituted, preferably unsubstituted, divalent aliphatic or cycloaliphatic hydrocarbon group.

Furthermore, very particularly preferably, the said light guides are those in which

p and q have the value 1,

Z₂ and Z₃ represent oxygen,

Z₁ represents oxygen or the group

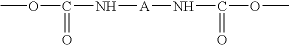

in which A is an unsubstituted or substituted, preferably unsubstituted, divalent group from an aliphatic or cycloaliphatic C₂-C₁₈ hydrocarbon, preferably the group

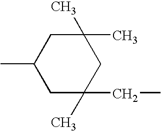

Z₄ represents oxygen or the group

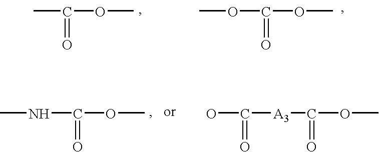

in which A₃ is an unsubstituted or substituted, preferably unsubstituted, C₂-C₁₈ group from an aliphatic or cycloaliphatic hydrocarbon,

A₁ is an ethylene or propylene-1,2 group and

A₂, A₃ and A₄, independently, are unsubstituted or substituted, preferably unsubstituted, divalent groups, preferably C₂-C₈ groups, from aliphatic or cycloaliphatic hydrocarbons.

Furthermore, very particularly preferred are said light guides in which, in formula (III)

A₅ is an unsubstituted or substituted, preferably unsubstituted, C₂-C₆ alkylene group,

Z₅ and Z₆, independently, represent oxygen or the —NH group and

R₃ is a C₁-C₁₈ alkyl group.

Furthermore, very particularly preferred are said light guides in which, in formula (III)

R₃ represents an unsubstituted or substituted, preferably unsubstituted, C₁-C₅ alkyl group,

A₅ represents an ethylene group and

Z₅ represents oxygen and Z₆ represents the —NH group.

It is preferred that, in the said coated light guides, the proportion of repeating units derived from the monomers mentioned under A) in the polymer is 25 to 75 wt. % and the proportion of repeating units derived from the monomers mentioned under B) in the polymer is 25 to 75 wt. % and wherein the sum of the proportions of repeating units derived from the monomers mentioned under A) and under B) in the polymer is 50 to 100 wt. %, particularly preferably 100 wt. %.

Furthermore, the invention provides a process for producing light guides according to the invention by coating the core of the light guide with a composition containing the monomers A) and B) and one or more different photoinitiators, wherein the composition is polymerised on the core by UV irradiation.

A process in which the proportion of photoinitiators in the composition is 0.1 to 10 wt. % is preferred.

Furthermore, the invention provides light guides obtainable by the process according to the invention.

Furthermore, the invention provides use of light guides according to the invention in means of transport.

Furthermore, the invention provides means of transport containing light guides according to the invention.

The solutions to the object according to the invention, which are the subject matter of the present invention, have numerous advantages. The advantageous properties of polycarbonate fibres, as mentioned above, are not impaired. They are in fact amplified by the coating according to the invention in light guides according to the invention. The optical, mechanical and thermal properties of polycarbonates according to the invention, and also of light guides according to the invention, are very good. The polycarbonate according to the invention has a low damping coefficient.

The rate of hardening of coatings according to the invention is very high, which enables an advantageous production process.

Coatings according to the invention ensure that there is no stress crack formation in the polycarbonate fibre.

The use of light guides according to the invention in means of transport is advantageous because light guides according to the invention enable a weight reduction as compared with known light guides, for example those made of glass. In addition, they have advantageous mechanical properties, in particular light guides according to the invention are unbreakable when compared with light guides made of glass. In addition, light guides according to the invention are much simpler to handle and enable better connection techniques. Copper cables are conventionally used for signal transfers in cars, in comparison with which a considerable weight reduction is possible.

Means of transport in the context of the present invention are in particular cars, track vehicles, ships and aircraft.

The monomers for coatings according to the invention are known or can be prepared by known processes. Some are commercially available.

Examples of D, as a tetravalent group from aliphatic or aromatic hydrocarbons, which may be mentioned are for example the parent hydrocarbon groups from tetravalent aliphatic alcohols such as e.g. pentaerythritol.

Examples of D, as a trivalent group from aliphatic or aromatic hydrocarbons, which may be mentioned are for example the parent hydrocarbon groups from aliphatic triols such as glycerine, trimethylolethane, trimethylolpropane or hexanetriol, aromatic tricarboxylic acids such as benzene-1,2,4 tricarboxylic acid or benzene-1,3,5 tricarboxylic acid or aromatic triisocyanates such as 2,4,6-toluylene triisocyanate or 4,4′,4″-triphenylmethane triisocyanate.

Examples of D, A₁, A₂, A₃, A₄ and A₅ as optionally substituted divalent groups from aliphatic, cycloaliphatic, araliphatic or aromatic hydrocarbons which may be mentioned are the parent hydrocarbon groups from in particular aliphatic diols such as ethylene glycol, 1,2-propanediol, 1,3-propanediol, 2,2-dimethyl-1,3-propanediol, 1,2-butanediol, 1,3-butanediol, 2,3-butanediol, 1,4-butanediol, 1,5-pentanediol, 1,6- and 2,5-hexanediol, diethylene glycol, triethylene glycol, dipropylene glycol, 2,2,4-trimethylpentanediol-1,3, 2-methylpentanediol-2,4 and 2-ethylhexanediol-1,3 or cycloaliphatic diols such as 2,2-dimethyl-4,4-dimethyl-cyclobutanediol, 1,2-cyclopentanediol, 1,3-cyclopentanediol, 1,2-, 1,3- and 1,4-cyclohexanediol, 1,4-bishydroxymethylcyclohexane, 2,2-bis-(4-hydroxycyclohexyl)-propane, 1-methyl-2,2-bis-(4-hydroxycyclohexyl)-ethane, 2-methyl-2,4-bis-(4-hydroxycyclohexyl)-pentane and bishydroxymethyl-hexahydro-4,7-methanoindane.

For A₃, in addition, the parent hydrocarbon groups from aliphatic dicarboxylic acids such as succinic acid, dimethylmalonic acid, glutaric acid, methylsuccinic acid, adipic acid, dimethylsuccinic acid, pimellic acid, suberic acid, azelaic acid, sebacic acid, decanedicarboxylic acid or dimeric fatty acid or cycloaliphatic dicarboxylic acids such as 1,2-, 1,3-, 1,4-cyclohexanedicarboxylic acid, and aromatic carboxylic acids such as terephthalic acid, isophthalic acid, phthalic acid, naphthalene-1,2, -1,4, -1,5, -1,8 dicarboxylic acids, 5-methylisophthalic acid, tetrahydrophthalic acid and hexahydroendomethylene-tetrahydrophthalic acid, may be mentioned.

Examples of A, as optionally substituted divalent groups from aliphatic, cycloaliphatic, araliphatic or aromatic hydrocarbons which may be mentioned are the parent hydrocarbon groups from in particular aliphatic diisocyanates such as hexamethylene diisocyanate or trimethylhexamethylene diisocyanate-1,6, cycloaliphatic diisocyanates such as cyclohexane-1,4 diisocyanate, cyclopentane-1,3 diisocyanate, methylene-bis-(4,4′-cyclohexyl) diisocyanate and 1-isocyanatomethyl-5-isocyanato-1,3,3-trimethylcyclohexane and aromatic diisocyanates such as 2,4- and 2,6-toluylene diisocyanate, 3,3′-dimethyl-4,4′-diphenylmethanediisocyanate, 4,4′-diphenylmethane diisocyanate and 4,4′-diphenylether diisocyanate.

Examples of R₃, as optionally substituted alkyl groups which may be mentioned are C₁-C₁₈ alkyl groups such as methyl, ethyl, propyl, n-butyl, sec.-butyl, i-propyl, tert.-butyl, i-butyl, pentyl, i-pentyl, neopentyl, heptyl, n-hexyl, 2-ethyl-hexyl, nonyl, decyl, cetyl, dodecyl and stearyl groups and, as cycloaliphatic groups, cyclopentyl and cyclohexyl groups, optionally substituted by methyl groups. Suitable araliphatic groups are primarily the benzyl group and benzyl groups substituted by methyl and lower alkoxy groups.

Compounds of the formula (I) (polyfunctional acrylic acid derivatives or methacrylic acid derivatives) are compounds which contain ether, ester, urethane and/or urea groups. Polyethers and/or polyester polyols are preferably reacted with acrylic acid derivatives or methacrylic acid derivatives.

Compounds of the formula (I) (monofunctional acrylates or methacrylates) are esters of acrylic acid or methacrylic acid which also contain an ester, urethane and/or urea group.

Polycarbonates according to the invention may contain conventional additives.

Light guides according to the invention may contain further constituents. By way of example, they may contain adhesion-promoting intermediate layers. For example, they may contain protective sheathing layers, in particular those which are flexible but resistant to aqueous solutions and to mineral oils and fuels, such as e.g. thermoplastic polyurethanes and rubbers.

Coatings according to the invention may contain conventional additives.

Coatings according to the invention may contain, in addition to components A and B, conventional additives such as e.g. solvents which are inert towards polycarbonates, polymerisation inhibitors, antioxidants, etc.

Photoinitiators are well-known and commercially available. The following may be mentioned as photoinitiators, for example: benzoin, benzoin ether, benzyl ketals, benzophenone, thioxanthone and their derivatives e.g. benzylmethyl ketal and 2-hydroxy-2-methyl-1-phenyl-propane-1-one.

Polycarbonates and the common methods for preparing them are described e.g. in “Chemistry and Physics of Polycarbonates” Polymer Rev. vol. 9, Interscience Publishers. They may optionally be prepared with the addition of known chain-terminators (see e.g. EP-A 0 010 602, DE-A 3 143 252), branching agents such as triphenols and/or isatinbiscresol (phenol) (see e.g. DE-A 1 570 533, DE-A 1 595 762, DE-A 2 500 092), stabilisers such as phosphanes and/or phosphites (see e.g. EP-A 0 143 906, DE-A 21 40 207) and mould release agents (see e.g. DE-A 2 507 748, DE-A 2 729 485 and DE-A 2 064 095). Processing the polycarbonates is preferably performed in a known manner by precipitating, spray-evaporating or extruding. The relative viscosity of a 0.5% strength solution of the polycarbonate in methylene chloride at 25° C. is preferably between 1.18 and 1.32.

Particularly preferred polycarbonates are the homopolycarbonate based on bisphenol A, the homopolycarbonate based on 1,1-bis-(4-hydroxyphenyl)-3,3,5-trimethylcyclohexane, the homopolycarbonate based on one of the following bisphenols

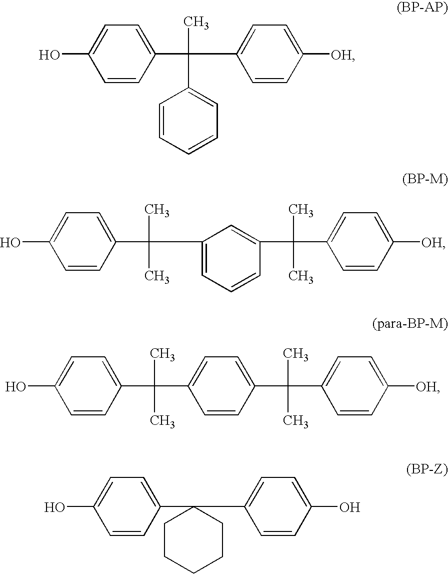

and the copolycarbonates made from combinations of the bisphenols mentioned, in particular the copolycarbonate based on the two monomers bisphenol A and 1,1-bis-(4-hydroxyphenyl)-3,3,5-trimethylcyclohexane.

The homopolycarbonate based on bisphenol A is very particularly preferred.

The polycarbonate preferably has a heavy metal content of less than 5 ppm, in particular less than 3 ppm, very particularly less then 0.5 ppm. Small concentrations of heavy metals cause a small degree of optical damping in the light guide.

The polycarbonate may be prepared by known processes, e.g. by the phase interface process from bisphenol and phosgene or by the melt transesterification process from carbonate and bisphenol.

The polycarbonate according to the invention with a low concentration of particles is preferably prepared as follows. The raw materials and solvent are filtered through a filter, preferably with a pore size of 0.25 to 15 μm, particularly preferably 0.5 to 5 μm. Spinning out, granulating and handling of the polycarbonate has to take place under clean conditions (clean room) with the exclusion of dust.

The viscosity of the compositions polymerisable by UV irradiation which is applied according to the invention to the polycarbonate fibres may be varied over wide limits by choosing the molecular weight of components A and B and/or by the ratio of components A and B and may be adjusted to the intended rates of spinning out and the spinning temperature of the polycarbonate fibres. The compositions to be used according to the invention preferably have a viscosity of 500 to 10 000 cP at 25° C. Compositions to be used according to the invention may preferably be processed at temperatures of 15 to 140° C.

In accordance with the process used, the polycarbonate core for the light guide of polycarbonate fibres may be produced first and this can be provided later with the coating materials to be applied according to the invention. However, it is more advantageous to apply the coating immediately after producing the polycarbonate fibres. The thickness of the coating to be applied according to the invention to the polycarbonate fibre is preferably less than 50 μm.

The light guides according to the invention may be processed to give single-strand or multiple-strand cables by encasing the light guides per se individually or by encasing several light guides made into a bundle with further polymer layers, e.g. by coextrusion. The polymer layer is then preferably a thermoplastic elastomer.

The light guides may be glued together to form a bundle.

The diameter of the light guides is preferably between 0.05 mm and 5 mm, particularly preferably 0.1 mm to 3 mm, very particularly preferably 0.25 to 1.5 mm.

Light guides according to the invention may also be used as illuminating elements. For this purpose, the surface of the light guides is damaged at the required points. This couples up the light. Alternatively, the light may be passed to the place which is required to be illuminated. For example, fittings, for example in electronic equipment such as radios or computers, may be illuminated in this way.

### EXAMPLES 1 to 12

(Coated Light Guides)

Examples 1 to 8 are in accordance with the invention. Examples 9 to 12 (mixtures 9 to 12) are comparison examples (comparison mixtures).

A polycarbonate fibre in accordance with the invention (diameter: 1.0 mm) was drawn vertically and centrally downwards through a vessel which had a die (diameter: 1.2 mm) in its base. The vessel was filled in turn with each of the coating mixtures described below. Simultaneous coating of the fibre with the mixture concerned took place through the annular gap left between the thread and the die.

Below the coating vessel was arranged, parallel to the thread, a 20 cm long mercury medium-pressure lamp (power: 120 W/cm), the radiation from which was focussed on the thread by means of a parabolic mirror in order to obtain the highest possible light yield for UV polymerisation of the coating mixture.

After passing over a guide roller, the coated thread was wound onto a large drum which ensured, via a motor-driven unit, that the thread was pulled through the unit, wherein the speed was a constant 5 m/min.

The thickness of the coating applied to the polycarbonate threads was in all cases 10 to 30 μm.

The polycarbonate fibres provided with a UV-polymerised coating were stored for 1 month at room temperature and then checked for any damage to the polycarbonate core, e.g. due to stress cracks. Table 1 below gives the results obtained for the individual mixtures and the compositions of the mixtures.

TABLE 1

| | | | | Behaviour |
|---|---|---|---|---|
| | Com- | | | of thread coated |
| | ponent A | | | with relevant mixture |
| | Reaction | | | on bending the thread |
| Mix- | product | | | round a circular rod with |
| ture | (parts | | Component B | 10 mm diameter after |
| no. | by wt.) | | (parts by wt.) | storage for one month |
| 1 | d | (50) | 1-(N-butyl-carbamoyl)- | no damage |
| | | | ethyl acrylate (50) | |
| 2 | e | (40) | 2-(N-butyl-carbamoyl)- | ″ |
| | | | ethyl acrylate (60) | |
| 3 | g | (40) | 2-(N-butyl-carbamoyl)- | ″ |
| | | | ethyl acrylate (60) | |
| 4 | b | (60) | 2-(N-butyl-carbamoyl)- | ″ |
| | | | ethyl acrylate (40) | |
| 5 | a | (60) | 2-(N-sec.-butyl-carbamoyl)- | ″ |
| | | | ethyl acrylate (40) | |
| 6 | c | (50) | 2-(N-butyl-carbamoyl)- | ″ |
| | | | ethyl acrylate (50) | |
| 7 | f | (50) | 2-(N-butyl-carbamoyl)- | ″ |
| | | | ethyl acrylate (50) | |
| 8 | h | (40) | 2-(N-butyl-carbamoyl)- | ″ |
| | | | ethyl acrylate (60) | |
| 9 | d | (50) | butyl acrylate (50) | fracturing on bending |
| 10 | h | (60) | N-vinylpyrrolidone (50) | some fracturing even |
| | | | | during storage |
| 11 | e | (50) | tetrahydrofurfuryl | some fracturing even |
| | | | acrylate (50) | during storage |
| 12 | a | (40) | 2-ethylhexyl acrylate (60) | fracturing on bending |

Note:
All mixtures 1 to 12 contained 3 parts by weight of the photoinitiator 2-hydroxy-2-methyl-1-phenyl-propane-1-one.

The maximum rate of hardening of the individual mixtures was determined for coated films in the simplified manner described below: the results obtained for films, however, cannot be readily transferred to fibres.

The mixtures were applied to a polycarbonate sheet with a manual spreader (film thickness: 50 μm). The coated polycarbonate sheets were passed under a UV irradiation unit (UV laboratory instrument from U. Steinemann AG: 80 W/cm) at a certain speed on a belt. The belt speed which just permitted complete hardening of the particular mixture was determined (=maximum belt speed [m/min]).

| | Max. rate of hardening |
|---|---|
| Mixture | (m/min) |
| 1 | 60 |
| 2 | >60 |
| 3 | >60 |
| 4 | >60 |
| 5 | >60 |
| 6 | >60 |
| 7 | >60 |
| 8 | 60 |
| 9 | 25 |
| 10 | >60 |
| 11 | 50 |
| 12 | 20 |

The reaction products a to h used as component A in mixtures 1 to 12 were obtained as follows:

Reaction Product a:

500 g of a linear polyether (average molecular weight: about 1 000; reaction product of propanediol-1,2 with propylene oxide), 167 g of 2-hydroxyethyl acrylate, 0.5 g of Desmorapid SO and 0.3 g of p-methoxyphenol were initially introduced into a 2 l flask provided with a stirrer, thermometer and gas inlet tube. Then 265 g of isophorone diisocyanate were added dropwise at 60 to 65° C. while dry air was passed through the mixture. The reaction mixture was then stirred at 60 to 65° C. until the NCO value had dropped to less than 0.1%.

Reaction Product b:

500 g of an OH group-containing linear polyester (average molecular weight: 1 000; OH value 112; reaction product of adipic acid and neopentyl glycol), 255 g of 2-hydroxyethyl acrylate and 350 g of isophorone diisocyanate were reacted in the way described for reaction product a).

Reaction Product c:

500 g of unbranched hydroxyl group-containing polyester (average molecular weight: 2 250; reaction product of adipic aid and butanediol), 300 g of 2-hydroxyethyl acrylate and 335 g of isophorone diisocyanate were reacted in the way described for reaction product a).

Reaction Product d:

500 g of a linear polypropylene glycol (average molecular weight: 2 000), 250 g of 2-hydroxyethyl acrylate and 290 g of isophorone diisocyanate were reacted in the way described for reaction product a).

Reaction Product e:

500 g of a hydroxyl group-containing linear polyester (average molecular weight: 1 000; OH value 112; reaction product of adipic acid and neopentyl glycol), 40 g of acrylic acid, 2 g of p-toluenesulfonic acid, 0.3 g of p-methoxyphenol, 0.3 g of di-tert.-butyl-hydroquinone and 190 g of toluene were initially introduced into a 1 l flask provided with a stirrer, thermometer, gas inlet tube and water separator and heated to reflux temperature while air was passed through the mixture. After elimination of the theoretical amount of water, the toluene was distilled off under vacuum.

The product obtained was then placed in a 1 l flask provided with a stirrer, thermometer and gas inlet tube and 0.1 g of Desmorapid SO and 0.05 g of di-tert.-butyl-hydroquinone were then added thereto and the mixture was heated to 60 to 65° C. At this temperature and while dry air was passed through the mixture, 50 g of isophorone diisocyanate were added dropwise. The reaction mixture was then stirred at 60 to 65° C. until the NCO value had dropped to less than 0.1%.

Reaction Product f:

500 g of a hydroxyl group-containing linear polyether (average molecular weight: 1 000; reaction product of propanediol-1,2 and propylene oxide), 40 g of acrylic acid, 2.7 g of p-toluenesulfonic acid, 0.3 g of p-methoxyphenol, 0.3 g of di-tert.-butyl-hydroquinone and 190 g of toluene were reacted in the way described for reaction product e) and, after distilling off the toluene, reacted with 50 g of isophorone diisocyanate in the same way as described for reaction product e).

Reaction Product g:

600 g of a linear hydroxyl group-containing polyester (average molecular weight: 2 000; reaction product of adipic acid and ethylene glycol, diethylene glycol and butanediol), 22.7 g of acrylic acid, 3.1 g of p-toluenesulfonic acid, 0.3 g of p-methoxyphenol, 0.3 g of di-tert.-butyl-hydroquinone and 220 g of toluene were reacted in the way described for reaction product d) and, after removing the toluene, reacted with 31.6 g of isophorone diisocyanate in the same way as described for reaction product e).

Reaction Product h:

500 g of a hydroxyl group-containing linear polyether (average molecular weight: 1 000; reaction product of propanediol-1,2 and propylene oxide), 500 g of 2-hydroxyethyl acrylate and 590 g of isophorone diisocyanate were reacted under the conditions described for reaction product a).

The damping coefficient of the light guide in accordance with example 1 was measured for three different polycarbonates (different particle contents). The following results were obtained:

### EXAMPLE 13

(According to the Invention; Number of Particles Per Gram of Polycarbonate)

| | |
|---|---|
| particles 0.6-1.0 μm: | 47 200 |
| particles 1.0-2.0 μm: | 3 100 |
| particles 2.0-5.0 μm: | 160 |
| particles 5.0-10 μm: | 40 |

Damping coefficient, measured at 660 nm: 2.3 dB/m

### EXAMPLE 14

(According to the Invention; Number of Particles Per Gram of Polycarbonate)

| | |
|---|---|
| particles 0.6-1.0 μm: | 21 300 |
| particles 1.0-2.0 μm: | 2 200 |
| particles 2.0-5.0 μm: | 310 |
| particles 5.0-10 μm: | 90 |

Damping coefficient, measured at 660 nm: 1.3 dB/m

### EXAMPLE 15

(Comparison; Number of Particles Per Gram of Polycarbonate)

| | |
|---|---|
| particles 0.6-1.0 μm: | 170 400 |
| particles 1.0-2.0 μm: | 21 700 |
| particles 2.0-5.0 μm: | 1 700 |
| particles 5.0-10 μm: | 400 |

Damping coefficient, measured at 660 nm: 3.2 dB/m

The damping coefficient was measured in accordance with the process described in Tamaka et al., “Fiber ander Integrated Optics”, vol. 7, page. 139 (1987).

The number of particles in the polycarbonate was measured using the “Hiac/Royco 346 BCL” instrument. This is a laser scanning instrument. The measurements were performed in a 2% strength solution in methylene chloride for particle, sizes up to 10 μm and in a 5% strength solution for particle sizes greater than 10 μm. Measurements were performed in accordance with the process which is described in U.S. Pat. No. 5,073,313 and in EP-A 379 130.

1. Polycarbonate containing less than 80 000 particles per gram of polycarbonate of particles insoluble in polycarbonate with a size of 0.3 to 10 μm.

2. Use of the polycarbonate according to claim 1 to produce light guides.

3. A light guide including a core containing the polycarbonate according to claim 1.

4. A light guide according to claim 3, wherein the core is coated.

5. A light guide-according to claim 4, wherein the coating contains a polymer which contains repeating units derived from the monomers
A) one or more different compounds of the formula (I) 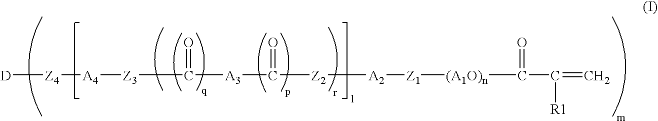
in which
m represents 2, 3 or 4,
D represents the m-valent group from an aliphatic or aromatic hydrocarbon,
R₁ is hydrogen or methyl,
Z₁, Z₂ and Z₃, independently, represent oxygen, sulfur, the —N(R) group (in which R is hydrogen or unsubstituted or substituted alkyl, aralkyl or aryl) or a divalent group of the formula (II) 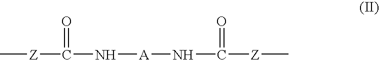
in which
Z represents oxygen, sulfur or the —N(R) group, and
A represents an unsubstituted or substituted divalent group from an aliphatic, cycloaliphatic, araliphatic or aromatic hydrocarbon,
Z₄ represents oxygen, the divalent group of the formula (II) or one of the following divalent groups 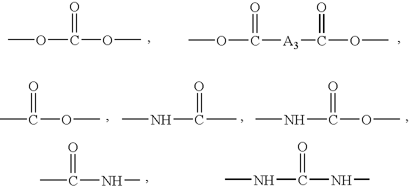
A₁, A₂, A₃ and A₄, independently, represent an unsubstituted or substituted divalent group from an aliphatic, cycloaliphatic, aromatic-aliphatic or aromatic hydrocarbon,
n is zero or an integer from 1 to 20,
p, q and r, independently, may take on the value zero or 1 and
l has a numerical value such that the weight average of the molecular weight of the compound of the formula (I) is 450 to 5000, and
B) one or more different compounds of the formula (III) 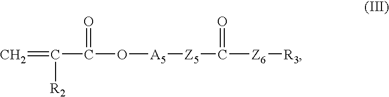
in which
R₂ is hydrogen or methyl,
A₅ represents an unsubstituted or substituted divalent group from an aliphatic or cycloaliphatic hydrocarbon,
Z₅ and Z₆, independently, represent oxygen, sulfur or the —N(R′) groups, in which R′ is hydrogen or unsubstituted or substituted alkyl, aralkyl or aryl, and
R₃ is an unsubstituted or substituted alkyl, cycloalkyl or aralkyl group.

6. A light guide according to claim 5, wherein A₁, A₂, A₃, A₄ and A, independently, represent an unsubstituted or substituted divalent aliphatic or cycloaliphatic hydrocarbon group.

7. A light guide according to claim 5, wherein
p and q have the value 1,
Z₂ and Z₃ represent oxygen,
Z₁ represents oxygen or the group 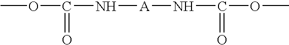
in which A is an unsubstituted or substituted divalent group from an aliphatic or cycloaliphatic C₂-C₁₈ hydrocarbon,
Z₄ represents oxygen or the group 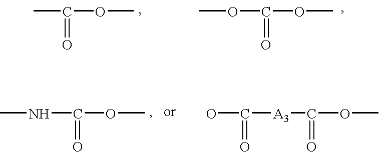
in which A₃ is an unsubstituted or substituted C₂-C₁₈ group from an aliphatic or cycloaliphatic hydrocarbon,
A₁ is an ethylene or propylene-1,2 group and
A₂, A₃ and A₄, independently, are unsubstituted or substituted divalent groups, preferably C₂-C₈ groups, from aliphatic or cycloaliphatic hydrocarbons.

8. A light guide according to any one of claims 5 to 7, wherein in formula (III)
A₅ is an unsubstituted or substituted C₂-C₆ alkylene group,
Z₅ and Z₆, independently, represent oxygen or the —NH group and
R₃ is a C₁-C₁₈ alkyl group.

9. A light guide according to any one of claims 5 to 8, wherein in formula (III),
R₃ represents an unsubstituted or substituted C₁-C₅ alkyl group,
A₅ represents an ethylene group and
Z₅ represents oxygen and Z₆ represents the —NH group.

10. A light guide according to any one of claims 5 to 9, wherein the proportion of repeating units in the polymer derived from the monomers mentioned under A) in claim 5 is 25 to 75 wt. % and the proportion of repeating units in the polymer derived from the monomers mentioned under B) in claim 5 is 25 to 75 wt. % and wherein the sum of the proportions of repeating units in the polymer derived from the monomers mentioned under A) and under B) in claim 5 is 50 to 100 wt. %.

11. A process for producing the light guide according to any one of claims 3 to 10 by coating the core of the light guide with a composition containing monomers A) and B) and one or more different photoinitiators, wherein the composition is polymerised on the core using UV irradiation.

12. A process according to claim 11, wherein the proportion of photoinitiator in the composition is 0.1 to 10 wt. %.

13. A light guide obtainable by the process according to claim 11 or 12.

14. Use of the light guide according to any one of claims 3 to 10 or according to claim 13 in means of transport.

15. A means of transport containing the light guide according to any one of claims 3 to 10 or according to claim 13.
